(19) United States
(12) Patent Application Publication
(10) Pub. No.: US 2024/0017513 A1
(43) Pub. Date: Jan. 18, 2024

(54) DEVICE AND METHOD FOR FORMING AND PRESSING A MOUTH PIECE OF A CONTAINER COMPRISING FIBERS

(71) Applicant: Krones AG, Neutraubling (DE)

(72) Inventors: Jochen Hirdina, Regensburg (DE); Frank Winzinger, Regensburg (DE)

(21) Appl. No.: 18/351,376

(22) Filed: Jul. 12, 2023

(30) Foreign Application Priority Data
Jul. 12, 2022 (DE) 102022117312.7

(51) Int. Cl. B31B 50/59

(52) U.S. Cl. CPC B31B 50/59; B31B 2120/002

(57) ABSTRACT

A device for forming and pressing a mouth piece of a container comprising fibers, for example pulp, wherein the device comprises a mold for surrounding at least one outer surface of a mouth region of the container in which the mouth piece is to be formed, wherein the mold comprises a structure for forming the mouth piece. The device also comprises a mandrel for introduction into an opening of the mouth region and a movement means for performing a relative movement between the mold and the mandrel to reduce a clearance of the mold and the mandrel, and thus to form and press the mouth piece. This disclosure also includes a method for forming and pressing a mouth piece of a container comprising fibers, for example pulp, using the device.

### CROSS-REFERENCE TO RELATED APPLICATION(S) AND CLAIM OF PRIORITY

This application claims priority to German Application No. 102022117312.7, filed Jul. 12, 2022, the disclosure of which is incorporated herein by reference.

### TECHNICAL FIELD

The invention relates to a device and a method for forming and pressing a mouth piece of a container comprising fibers.

### BACKGROUND

In the production of containers from fibers, for example pulp, there are high demands for strength and stability of the mouth section. For example, it is known that a mouth piece made of a different material is subsequently added to the container formed from pulp. The mouth piece can also be formed from pulp by inflating a balloon in the container.

### SUMMARY

The object of the invention is to provide a device and a method which enable a formation of a dimensionally stable mouth piece of a container comprising fibers, for example pulp.

The object is achieved by the device and the method of this disclosure and embodiments therein.

The device according to the invention for forming and pressing a mouth piece of a container comprising fibers, for example a pulp, comprises a mold for surrounding at least one outer surface of a mouth region of the container in which the mouth piece is to be formed, wherein the mold comprises a structure for forming the mouth piece. In addition, the device comprises a mandrel, in particular for introduction into an opening at least temporarily within the mouth region, and movement means for executing a relative movement between the mold and the mandrel to reduce a clearance of the mold and the mandrel, and thus to form and press the mouth piece.

The fibers can, for example, be at least in part plant fibers, for example comprising wood pulp and/or cellulose. Pulp may comprise a suspension of water and fibers, e.g., cellulose, such as paper fibers and/or wood fibers.

The mouth region, and the mouth piece to be formed and pressed in the mouth region, can be regarded as belonging to the container. The mouth region can be of one piece with the container and comprise the same material as the container. Depending on the container, the mouth region can have an internal diameter of 0.1 cm to 10 cm, for example of 1.5 cm to 6 cm. In the case of drums, the mouth region can have an internal diameter of up to one meter.

In the forming of the opening of the mouth region, the mandrel can already be arranged in said mouth region or even contribute to the formation of the opening, or alternatively can be introduced into the opening only after said opening has been formed.

The mouth region can be regarded as a raw version of the mouth piece. The raw version can, for example, comprise no threading, no support ring, and/or no engagement elements. A threading, a support ring, and/or engagement elements can, for example, be shaped and pressed, and thus be formed, for example, by means of the structure of the mold.

Executing the relative movement can mean that the mold can be designed to be movable by means of the movement means, whereas the mandrel can be designed to be stationary.

Alternatively, the execution of the relative movement can mean that the mandrel can be designed to be movable by means of the movement means, whereas the mold can be designed to be stationary. The mandrel can be designed in multiple parts, for example, wherein one or more of the parts can be designed to be movable.

Alternatively, it can be provided that the execution of the relative movement can mean that both the mold and the mandrel can be designed to be movable by means of the movement means. The mandrel can be designed in multiple parts, for example, wherein one or more of the parts can be designed to be movable.

The clearance of the mold and the mandrel can be reduced, by means of the movement means, to form and press the mouth piece. It can be provided that the movement means for executing a relative movement between the mold and the mandrel can be further designed to increase a clearance of the mold and the mandrel. For example, after completion of the mouth piece, via the forming and pressing, the mold and the mandrel can be removed from one another so that the mouth piece arranged between them can be removed. It can be provided that the mandrel can be extracted from an opening of the mouth piece after completion of said mouth piece. The opening of the mouth piece can correspond to the opening of the mouth region, which can have been formed via the forming and pressing by means of the mold and the mandrel.

For forming and pressing, the mold and the mandrel can interact functionally in such a way that the opening region arranged between them can be made into the mouth piece. A pressure during pressing can be in a range of from 10,000 N/m 2 (0.1 bar) to 100,000,000 N/m 2 (1000 bar), for example from 100,000 N/m 2 (1 bar) to 10,000,000 N/m 2 (100 bar) or, for example, from 500,000 N/m 2 (5 bar) to 5,000,000 N/m 2 (50 bar).

The mold can be in one piece or in multiple parts. Accordingly, the structure can be in one or more parts.

For example, to form and press a mouth piece with round cross-section, the mandrel and the mold can comprise substantially circular-cylindrical cross-sections.

The structure can comprise a negative mold of a threading and/or support ring to be formed and/or of engagement elements to be formed.

The relative movement can comprise a movement of the mold in the direction of the mandrel, or can comprise a movement in the direction away from the mandrel. The movement can be provided radially in the direction toward the mandrel or radially in the direction away from the mandrel. Radially can hereby mean relative to a longitudinal axis of the mandrel.

The relative movement can comprise a movement of the mandrel in the direction of the mold, or can comprise a movement in the direction away from the mold.

The mandrel can comprise a planar lateral surface. For example, the planar lateral surface can be a lateral surface of a circular cylinder. Upon execution of a relative movement, by means of the movement means, between the mold and the mandrel to reduce the clearance of the mold and the mandrel, the mold, which comprises the structure, can contact the mouth region and the mouth region can press against the planar lateral surface so that the mouth piece can be formed and pressed.

The mandrel can comprise at least two radially movable jaws with planar lateral surface segments, wherein, for example, two radially movable jaws can be provided which can each comprise a cylinder segment of approximately 180°, or wherein, for example, four radially movable jaws can be provided which can each comprise a cylinder segment of approximately 90°. Three jaws of approximately 120° would also be conceivable. In order to be able to ensure a relative mobility of the jaws, these can respectively extend (over their entire height) less (e.g., to 5°) than 360°/(number of jaws) of the circumference.

In an alternative embodiment, the jaws can overlap in regions in the circumferential direction, at least at their edges. The overlap can, for example, be formed by means of a plurality of projections along the height in the manner of a zipper. Thus, projections of one jaw can engage between projections of the adjacent jaw. This can result in that at least one jaw, for example all jaws, extends in the circumferential direction by more than 360°/(number of jaws). For example, three jaws could be provided which each extend by 125° in the circumferential direction.

For forming and pressing the mouth piece, the radially movable jaws can be moved radially away from a longitudinal axis of the mandrel, for example.

Upon executing a relative movement by means of the movement means between the mold and the mandrel to reduce the clearance of the mold and the mandrel, the movable jaws can contact the mouth region and can press it against the mold so that the mouth piece can be formed and pressed.

It may occur that, due to the radial movement away from the longitudinal axis of the mandrel, portions of the mouth region cannot be contacted by one of the radially movable jaws. The mandrel can therefore be rotated by an angular range about its longitudinal axis, wherein the angular range can be unequal to an angle size of a cylinder segment of the jaw. For example, a rotation by 45°, 135°, 225°, or 315° can be provided in the event of angle sizes of the cylinder segments of 90° in each case. By rotating the mandrel, burrs in the interior of the mouth piece can be avoided. Instead, it can be provided that, after a first forming and pressing operation, the radially movable jaws can first be moved radially toward the longitudinal axis of the mandrel before the mandrel can be rotated by an angular range about its longitudinal axis, wherein the angular range can be unequal to an angle size of a cylinder segment of the jaw.

After execution of the rotation, to form and press the mouth piece the radially movable jaws can again be moved radially away from a longitudinal axis of the mandrel, for example, so that, upon execution of a relative movement by means of the movement means between the mold and the mandrel to reduce the clearance of the mold and the mandrel, the movable jaws can contact the mouth region and can press it against the mold so that the mouth piece can be formed and pressed.

Respectively, at least one inclined plane can be provided on a rear side of the planar lateral surface segments, and the mandrel further comprises a spreading rod that is movable parallel to the longitudinal axis of the mandrel, wherein an interaction of the at least one inclined plane and the spreading rod can produce a radial movement of the radially movable jaws. The radially movable jaws can be moved, for example radially away from a longitudinal axis of the mandrel, by the interaction of the at least one inclined plane and the spreading rod to form and press the mouth piece. Upon executing a relative movement by means of the movement means between the mold and the mandrel to reduce the clearance of the mold and the mandrel, the movable jaws can contact the mouth region and can press it against the mold so that the mouth piece can be formed and pressed. As described previously, a rotation of the mandrel about its longitudinal axis can also be provided.

The mandrel can comprise a hydraulic system which, in cooperation with the radially movable jaws, can produce a radial movement of the radially movable jaws.

The mandrel can comprise at least one toggle per radially movable jaw, wherein an interaction of the at least one toggle and the radially movable jaw can produce a radial movement of the radially movable jaw. The previously described interactions of mouth region, jaws, and mold can also apply here. It can also be provided that, as described above, the mandrel can be designed to be rotatable about its longitudinal axis.

The device can further comprise rotary means for executing a rotation of the mandrel about its longitudinal axis.

A method for forming and pressing a mouth piece of a container comprising fiber, for example pulp, for example using a device as described further above or further below, comprises providing a container comprising fiber, for example pulp, having a mouth region which comprises an opening in which a mandrel is arranged at least temporarily, for example an introduction of the mandrel into the opening, a surrounding, with the mold, of at least one outer surface of the mouth region of the container in which the mouth piece is to be formed, and execution of a relative movement between the mold and mandrel by means of the movement means to reduce a clearance of the mold and mandrel, and thereby forming and pressing the mouth piece.

The execution of the relative movement to reduce the clearance may comprise moving the mold, by means of the movement means, radially in the direction of the mandrel, for example radially in the direction of a longitudinal axis of the mandrel, wherein the mandrel is stationary; moving the mold, by means of the movement means, radially in the direction of the mold, for example radially away from the longitudinal axis of the mandrel, wherein the mold is stationary; or moving the mold, by means of the movement means, in the direction of the mandrel, for example radially in the direction of a longitudinal axis of the mandrel, and moving the mandrel, by means of the movement means, in the direction of the mold, for example radially away from the longitudinal axis of the mandrel.

In addition, features as have already been mentioned with regard to the device in connection with the execution of the relative movement for reducing the clearance are also applicable to the method, since the method uses this device.

Furthermore, the method can comprise moving the radially movable jaws of the mandrel away from a longitudinal axis of the mandrel. This applies to an embodiment of the device in which the mandrel can comprise at least two radially movable jaws with planar lateral surface segments, as have already been described further above. Features have already been made with respect to the mandrel with radially movable jaws in connection with the device also applicable to the method, since the method uses this device.

The method can further comprise a rotation of the mandrel by an angular range. For example, moving the radially movable jaws of the mandrel toward the longitudinal axis of the mandrel can be provided before the rotation. Moving the radially movable jaws of the mandrel away from the longitudinal axis of the mandrel can then be provided after the rotation.

Here, too, features as were already made in connection with the device are applicable to the method.

The method can further comprise, for example after the forming and pressing of the mouth piece, a movement of the mold away from the longitudinal axis of the mandrel and/or a movement of the radially movable jaws of the mandrel toward the longitudinal axis of the mandrel, if the mandrel comprises radially movable jaws. The mold and/or the radially movable jaws can thereby be removed from the mouth region or the formed and pressed mouth piece. The container comprising fibers, for example pulp, with the formed and pressed mouth piece can then be supplied to further processing steps, for example.

The mandrel can be designed for the transport and/or retention of the mouth piece after the forming, possibly including remaining parts of the container, i.e., the entire container. The mouth piece can thus be taken over by other handling devices, for example. During retention or transport, a lower pressure can be exerted by the jaws.

Upon pressing, as much of the liquid fraction of the fibers, for example of the pulp, as possible can be pressed out, so that the mouth piece has only a low residual moisture content.

The mouth piece can comprise one or more or all of the following characteristics: a support ring for the transport of the container in neck handling; a lock ring for engaging a retaining ring of a closure; a thread for screwing onto a closure; and/or a sign, for example in the form of a number, for identifying the mold or the mandrel with which the mouth piece was pressed.

For example, the device can have a plurality of similar molds and mandrels in order to be able to simultaneously produce a plurality of mouth pieces.

Furthermore, the device can comprise, in addition to the previously described forms according to the invention, deposition molds in which basic shapes of the mouth pieces to be formed are formed (without such high pressure), whereupon the basic shapes can be transported by a handling device into the previously described molds. Alternatively, the mouth pieces to be formed can be formed in the mold according to the invention from an unshaped mass comprising fibers.

The device can further comprise a mixer with which the mass (e.g., pulp) can be produced. The device can comprise a pump which can pump the mass toward the mold.

The mold and/or the mandrel can have holes through which the expressed liquid can be discharged. The holes can be bores or pores of the material of which the mold and/or the mandrel consist, at least in regions. Furthermore, channels for discharging the liquid can be arranged within the mandrel and/or the mold.

### BRIEF DESCRIPTION OF THE DRAWINGS

The accompanying Figures show, by way of example, aspects and/or exemplary embodiments of the invention for better understanding and illustration. Shown are:

FIG. 1 illustrates a schematic semi-longitudinal section of a first embodiment of a device for forming and pressing a mouth piece of a container comprising fibers;

FIG. 2 illustrates a schematic partial longitudinal section of a second embodiment of a device for forming and pressing a mouth piece of a container comprising fibers;

FIG. 3A illustrates a schematic plan view of a first arrangement of mold and mandrel for forming and pressing a mouth piece;

FIG. 3B illustrates a schematic plan view of a second arrangement of mold and mandrel for forming and pressing a mouth piece;

FIG. 3C illustrates a schematic plan view of a third arrangement of mold and mandrel for forming and pressing a mouth piece;

FIG. 3D illustrates a schematic plan view of a fourth arrangement of mold and mandrel for forming and pressing a mouth piece;

FIG. 4 illustrates a schematic semi-longitudinal section of a second embodiment of a device for forming and pressing a mouth piece of a container comprising fibers, in a first arrangement; and

FIG. 5 illustrates a schematic semi-longitudinal section of the second embodiment of the device in a second arrangement.

### DETAILED DESCRIPTION

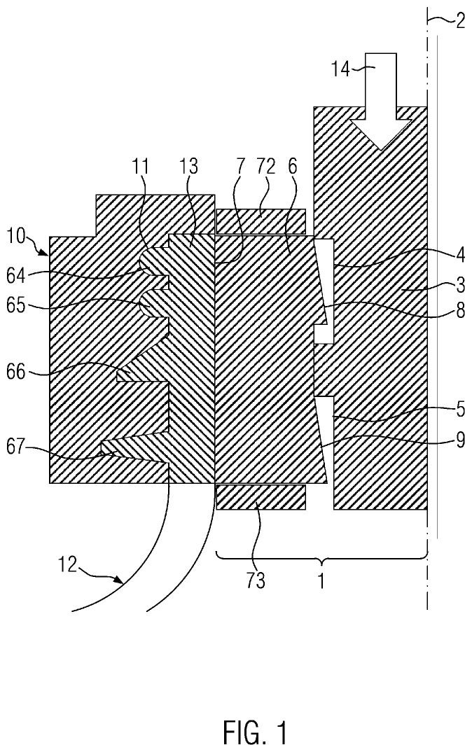

FIG. 1 shows a schematic semi-longitudinal section of a first embodiment of a device for forming and pressing a mouth piece 13 of a container 12 comprising fibers, for example pulp.

In the sectional representation, the mandrel 1 comprises a radially movable jaw 6 with a planar lateral surface segment 7, on the rear side of which are provided two inclined planes 8, 9 arranged one above the other as seen along the longitudinal axis 2 of the mandrel 1. In the sectional representation, the mandrel 1 further comprises a spreading rod 3 that can be moved parallel to the longitudinal axis 2 of the mandrel 1. The spreading rod 3 comprises, on its surface which points toward the jaw 6, two recesses 4, 5 arranged one above the other as seen along the longitudinal axis 2 of the mandrel 1. In the event of a movement of the spreading rod 3 parallel to the longitudinal axis 2 in a direction 14 into the interior of the container 12, an interaction of the inclined planes 8, 9 and the recesses 4, 5 causes a radial movement of the radially movable jaw 6 in the direction toward a mold 10. Alternatively, the recesses 4, 5 can likewise have inclined planes or rolling bodies for moving on the inclined planes (not shown). In a further alternative (not shown), the mandrel 1 can comprise rolling elements, recesses, or inclined planes only at one height. Two, three, or more rolling elements, recesses, or inclined planes can be arranged in the circumferential direction.

The mold 10, which comprises a structure 11 for forming the mouth piece 13, surrounds at least one outer surface of the container 12 in which the mouth piece 13 is to be formed.

Due to the radial movement of the jaw 6 in the direction toward the mold 10, the clearance between the jaw 6 and the mold 10 decreases and the mouth region of the container 12 can be pressed into the structure 11 of the mold, and the mouth piece 13 can thus be formed or finished. The remainder of the container 12 is not necessarily connected to the mouth piece in this state.

Guides 72, 73 for the jaw movement can be seen above and below the jaw 6.

In the sectional representation, two thread turns 64, 65 of the mouth piece 13 and a lock ring 66 and a support ring 67 of the mouth piece 13 can be seen. In a subsequent processing step, a tear-off ring of a closure can be placed between lock ring 66 and support ring 67, which tear-off ring can be detached at least partially from the remainder of the closure upon unscrewing the closed container 12.

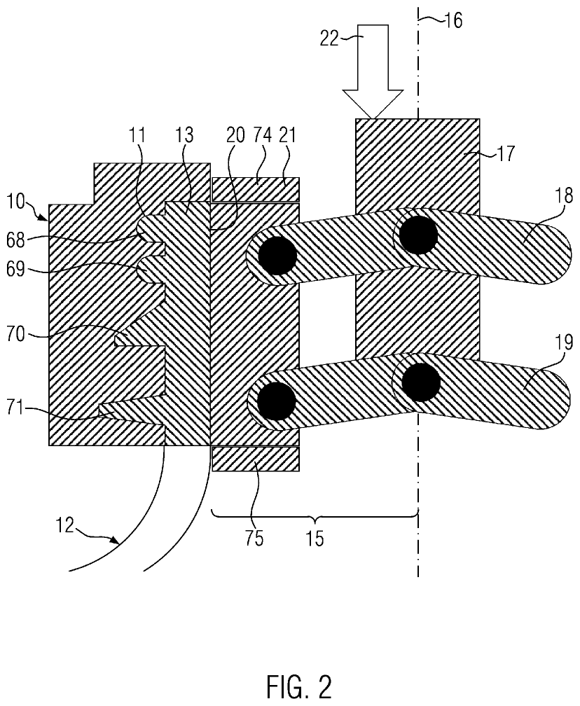

FIG. 2 shows a schematic partial longitudinal section of a second embodiment of a device for forming and pressing a mouth piece 13 of a container 12 comprising fibers, for example pulp.

In the sectional representation, the mandrel 15 comprises a radially movable jaw 21 with a planar lateral surface segment 20 and a rod 17, which are connected to the jaw with two toggles 18, 19. In the event of a movement of the rod 17 parallel to the longitudinal axis 16 of said rod 17 in a direction 22 into the interior of the container 12, an interaction of the toggles 18, 19 with the jaw 21 causes a radial movement of the radially movable jaw 21 in the direction toward the mold 10.

Due to the radial movement of the jaw 21 in the direction toward the mold 10, the clearance between the jaw 21 and the mold 10 decreases and the mouth region of the container 12 can be pressed into the structure 11 of the mold 10, and the mouth piece 13 can thus be formed or finished. Guides 74, 75 for the jaw movement can be seen above and below the jaw 21.

The mold 10 and the structure 11 correspond to those from FIG. 1.

In the sectional representation, two thread turns 68, 69 of the mouth piece 21 and a lock ring 70 and a support ring 71 of the mouth piece 13 can be seen. In a subsequent processing step, a tear-off ring of a closure can be placed between lock ring 70 and support ring 71, which tear-off ring can be detached at least partially from the remainder of the closure upon unscrewing the closed container 12.

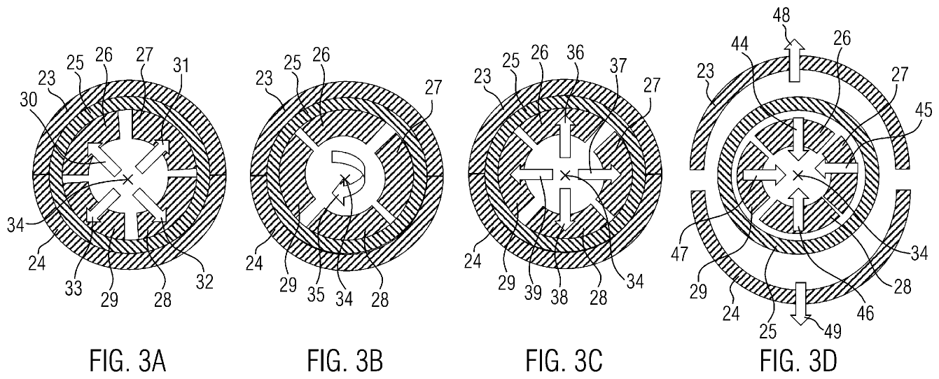

FIG. 3A shows a schematic plan view of a first arrangement of mold and mandrel for forming and pressing a mouth piece. The mold comprises two parts 23, 24 which surround a mouth piece 25 of a container comprising a fiber, for example pulp. For the sake of clarity, only the exemplary four radially movable jaws 26, 27, 28, 29 of the mandrel are shown.

A radial movement of the jaws 26-29 can be carried out by means of, for example, the elements of the embodiments shown in FIGS. 1 and 2. In FIG. 3A, the jaws 26-29 are moved radially away from a longitudinal axis 34 of the mandrel. The clearance between the mold and the jaws 26-29 can thereby be reduced, whereby the mouth piece 25 can be formed by pressing into a structure (not shown) of the mold.

Due to the radial movement away from the longitudinal axis 34, portions of the mouth piece 25 are not contacted by the four jaws 26-29. The mandrel can therefore be rotated by an angular range about its longitudinal axis, wherein the angular range can be unequal to an angle size of a cylinder segment of the jaws 26-29. By rotating the mandrel, burrs in the interior of the mouth piece 25 can be avoided.

FIG. 3B shows a schematic plan view of a second arrangement of mold and mandrel for forming and pressing a mouth piece 25. The radial movement of the jaws 26-29 away from the longitudinal axis 34 was stopped, and the mandrel was rotated by 45° in the clockwise direction 35 about the longitudinal axis 34.

Generally speaking, an inner and/or outer mold 1, 23, 24, 26-29 can rotate between two pressing operations by an angle relative to the mouth piece 13, 25 to be formed, which angle is dimensioned such that, in the second pressing operation, a molded part is situated at the position which was arranged between two molded parts in the first pressing operation.

FIG. 3C shows a schematic plan view of a third arrangement of mold and mandrel for forming and pressing a mouth piece. After the end of the rotation by 45° in the clockwise direction 35 about the longitudinal axis 34, the jaws 26-29 are again moved radially away from the longitudinal axis 34, and the mouth piece 25 can be formed by re-pressing into the structure of the mold.

The position of the two parts 23, 24 of the mold is not changed.

FIG. 3D shows a schematic plan view of a fourth arrangement of mold and mandrel for forming and pressing a mouth piece. After the forming and pressing of the mouth piece 25, i.e., for example after its completion, the one part 23 of the mold can be moved radially away from the longitudinal axis 34 in a direction 48, and the other part 24 of the mold can be moved radially away from the longitudinal axis 34 in a direction 49, in order to form a clearance with respect to the mouth piece 25. In addition, the jaws 26-29 can in each case be moved radially toward the longitudinal axis 34 in a direction 44, 45, 46, 47 in order likewise to form a clearance with respect to the mouth piece 25. The planar lateral surface segments 40, 41, 42, 43 of the respective jaws 26-29 can also be seen in FIG. 3D.

The procedure according to FIGS. 3A to 3D is not suitable if a thread is to be impressed by the rotating mold(s) or the rotating mandrel. However, the form(s) or the mandrel could be correspondingly replaced by another one for the second pressing operation.

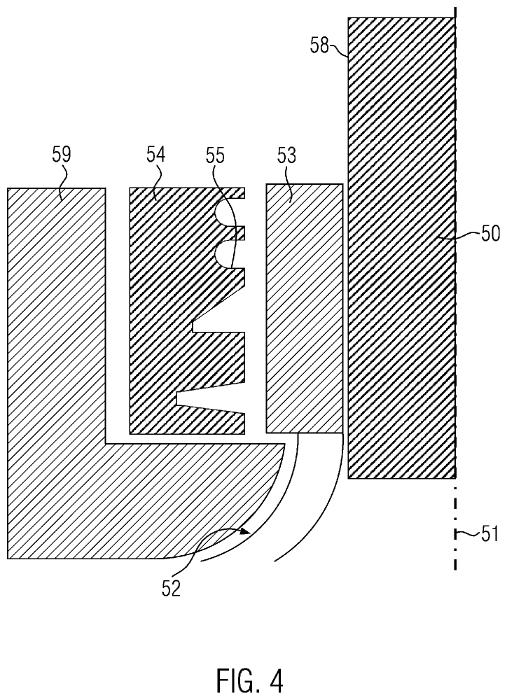

FIG. 4 shows a schematic semi-longitudinal section of a second embodiment of a device for forming and pressing a mouth piece of a container 52 comprising fibers, for example pulp, in a first arrangement. A mandrel 50 with a planar lateral surface 58, which comprises a longitudinal axis 51, is introduced into the container 52. A mold 54 that comprises a structure 55 for forming the mouth piece surrounds at least one outer surface of the mouth region 53 of the container 52 in which the mouth piece is to be formed. In the illustrated first arrangement, the mold 53 has a clearance from the outer surface of the mouth region 53. The mold 53 is hereby arranged in a mold extension 59. In the illustration, the mold extension 59 extends around the mouth region 53 as well as a portion of a neck region of the container 52. Alternatively, the mold extension 59 can also extend to the base (not shown) of the container 52.

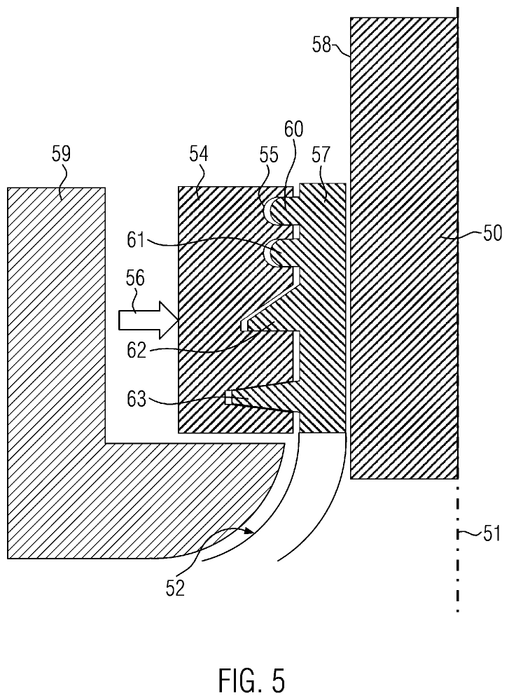

FIG. 5 shows a schematic semi-longitudinal section of the second embodiment of the device, in a second arrangement. The mold 54 was moved radially toward the longitudinal axis 51 in a direction 56, whereby the clearance between the mold 54 and the mandrel 50 decreases, the mouth region 53 (see FIG. 4) of the container 52 is pressed into the structure 53 of the mold 54, and the mouth piece 57 can thus be formed or finished.

In the illustration of the semi-longitudinal section, two thread turns 60, 61 of the mouth piece 57 as well as a lock ring 62 and a support ring 63 of the mouth piece 57 can be seen. In a subsequent processing step, a tear-off ring of a closure can be placed between lock ring 52 and support ring 63, which tear-off ring can be detached at least partially from the remainder of the closure upon unscrewing the closed container 52.

1. A device for forming and pressing a mouth piece of a container comprising fibers, the device comprising:
a mold for surrounding at least one outer surface of a mouth region of the container in which the mouth piece is to be formed, wherein the mold comprises a structure for forming the mouth piece;
a mandrel, for introduction into an opening, at least temporarily within the mouth region; and
a movement means for performing a relative movement with respect to a longitudinal axis of the mandrel, between the mold and the mandrel to reduce a clearance of the mold and the mandrel, and to form and press the mouth piece.

2. The device of claim 1, wherein the structure comprises a negative mold of:
a thread to be formed;
a support ring to be formed; and/or
engagement elements to be formed.

3. The device of claim 1, wherein the relative movement comprises a movement of the mold in a direction toward the mandrel or in a direction away from the mandrel.

4. The device of claim 1, wherein the relative movement comprises a movement of the mandrel in a direction toward the mold or in a direction away from the mold.

5. The device of claim 1, wherein the mandrel comprises a planar lateral surface.

6. The device of claim 1, wherein the mandrel comprises at least two radially movable jaws with planar lateral surface segments, wherein:
the mandrel comprises two radially movable jaws that each comprise a cylinder segment of 180°; or
the mandrel comprises four radially movable jaws that each comprise a cylinder segment of 90°.

7. The device of claim 6, wherein at least one inclined plane is provided on a rear side of each of the planar lateral surface segments, and the mandrel further comprises a spreading rod that is movable parallel to the longitudinal axis of the mandrel,
wherein an interaction of the at least one inclined plane and the spreading rod can produce a radial movement of the radially movable jaws.

8. The device of claim 6, wherein the mandrel comprises a hydraulic system which, in interaction with the radially movable jaws, can produce a radial movement of the radially movable jaws.

9. The device of claim 6, wherein the mandrel comprises at least one toggle per radially movable jaw, wherein an interaction of the at least one toggle and the radially movable jaw can produce a radial movement of the radially movable jaw.

10. The device of claim 1, further comprising a rotating means for executing a rotation of the mandrel about the longitudinal axis of the mandrel.

11. A method for forming and pressing a mouth piece of a container comprising fibers using a device, wherein the method comprises:
providing a container comprising fibers having an opening in which a mandrel of the device is arranged at least temporarily;
optionally introducing the mandrel into the opening;
surrounding, with a mold of the device, at least one outer surface of a mouth region of the container in which the mouth piece is to be formed; and
executing a relative movement with respect to a longitudinal axis of the mandrel, between the mold and the mandrel to reduce a clearance of the mold and the mandrel, thereby forming and pressing the mouth piece.

12. The method of claim 11, wherein executing the relative movement to reduce the clearance comprises:
moving the mold radially in a direction of the longitudinal axis of the mandrel, wherein the mandrel is stationary;
moving the mandrel in a direction of the mold radially away from the longitudinal axis of the mandrel, wherein the mold is stationary; or
moving the mold in the direction of the longitudinal axis of the mandrel and moving the mandrel in the direction of the mold radially away from the longitudinal axis of the mandrel.

13. The method of claim 11, further comprising moving radially movable jaws of the mandrel away from the longitudinal axis of the mandrel.

14. The method of claim 13, further comprising rotating the mandrel by an angular range.

15. The method of claim 11, further comprising, after forming and pressing the mouth piece:
moving the mold away from the longitudinal axis of the mandrel; and/or
moving radially movable jaws of the mandrel toward the longitudinal axis of the mandrel.
